(19) United States
(12) Patent Application Publication
(10) Pub. No.: US 2012/0117470 A1
(43) Pub. Date: May 10, 2012

(54) Learning Tool for a Ribbon-Shaped User Interface

(75) Inventors: Jennifer Michelstein, Kirkland, WA (US); Jonas Fredrik Helin, Kirkland, WA (US); Abhishek Agrawal, Seattle, WA (US); Stephen Courtney, Redmond, WA (US)

(73) Assignee: MICROSOFT CORPORATION, Redmond, WA (US)

(21) Appl. No.: 12/943,668

(22) Filed: Nov. 10, 2010

(51) Int. Cl. G06F 3/048

(52) U.S. Cl. 715/709

(57) ABSTRACT

A computing device displays a user interface containing a ribbon-shaped user interface. The ribbon-shaped user interface contains multiple tabs. Each of the tabs contains multiple controls. Furthermore, a challenge and a tab visualization control are displayed in the user interface. The challenge instructs a user of the computing device to perform a task using the ribbon-shaped user interface without instructing the user how to perform the task. In response to receiving selection of the tab visualization control, the computing device displays a popup window in the user interface. The popup window initially contains an image of an initial portion of a given tab in the ribbon-shaped user interface. The image of the given tab is scrolled within the popup window such that a target control in the given tab is visible within the popup window.

### BACKGROUND

Modern productivity applications enable users to perform a large number of commands on documents. For example, a word processor application can enable a user to manipulate the appearance of text, insert tables, insert footnotes, create tables of content, add page numbers, review changes, and so on. In another example, a spreadsheet application can enable a user to select styles for cells, create and insert charts, set the layout for spreadsheet pages, and so on.

Traditionally, productivity applications have used menu systems to enable users to select and perform commands on documents. A menu system comprises a set of menus. Each of the menus contains one or more menu items. Selection of a menu item can cause a productivity application to perform a command on a document, open an interface that provides the user with more options, or perform some other action. Menu systems can be beneficial because menu systems frequently do not occupy large amounts of onscreen space. However, users can find it difficult to find valuable commands because the menu items associated with those commands can be located somewhere deep within one of the menus. Moreover, it can take several clicks for a user to select the desired menu item.

In addition to menu systems, some productivity applications provide toolbars. A toolbar comprises a fixed set of selectable icons associated with commands. The icons can graphically suggest the effect of the performing the commands associated with the icons. Selection of an icon can cause the productivity application to perform some command. Toolbars can be beneficial because the graphical icons can help users more easily understand the associated commands. Furthermore, toolbars can be beneficial because toolbars can remain onscreen and thus can be selected with a single click. However, it may be difficult for a user to determine which icons are associated with which commands. Labeling the icons with text can cause each icon to become so large that the toolbar occupies an unacceptable amount of onscreen space.

A ribbon-shaped user interface can include a set of toolbars placed on tabs in a tab bar. The tab bar can be rectangular in shape. Ribbon-shaped user interfaces can have the benefits of toolbars in that users can see and select graphical icons to perform commands. Furthermore, ribbon-shaped user interfaces can have some of the benefits of menu systems because not all of the icons are onscreen at once. As a result, a ribbon-shaped user interface can occupy less onscreen space than a toolbar containing the same number of icons.

However, it can still be challenging for users to learn how to use a ribbon-shaped user interface. This can especially be true for users accustomed to menu systems or menu systems accompanied by one or more static toolbars. Because users can find it difficult to learn how to use ribbon-shaped user interfaces, users may never learn how to use potentially valuable commands provided by productivity applications.

### SUMMARY

A computing device displays a user interface containing a ribbon-shaped user interface. The ribbon-shaped user interface contains multiple tabs. Each of the tabs contains multiple controls. Furthermore, the computing device displays a challenge and a tab visualization control in the user interface. The challenge instructs a user of the computing device to perform a task using the ribbon-shaped user interface. However, the challenge does not instruct the user how to perform the task. If the user does not know how to perform the task using the ribbon-shaped user interface, the user can select the tab visualization control. In response to receiving selection of the tab visualization control, the computing device displays a popup window in the user interface. The popup window initially contains an image of an initial portion of a given tab in the ribbon-shaped user interface. The image of the given tab is scrolled within the popup window such that a target control in the given tab is visible within the popup window. The user may need to use the target control to perform the task. Scrolling the image of the given tab within the popup window can help the user learn the location of the target control within the tab.

This summary is provided to introduce a selection of concepts. These concepts are further described below in the Detailed Description. This summary is not intended to identify key features or essential features of the claimed subject matter, nor is this summary intended as an aid in determining the scope of the claimed subject matter.

### BRIEF DESCRIPTION OF THE DRAWINGS

FIG. 1 is a block diagram illustrating a first example embodiment.

FIG. 2 is a block diagram illustrating a second example embodiment.

FIG. 3 illustrates an example user interface of a productivity application provided by the computing device.

FIG. 4 illustrates example details of a document pane of the user interface.

FIG. 5 illustrates example details of a learning tool pane before the user selects a hint control in the learning tool pane.

FIG. 6 illustrates example details of the learning tool pane shown in the example of FIG. 5 after the user selects the hint control in the learning tool pane.

FIG. 7 illustrates an initial view of a popup window.

FIG. 8 illustrates a scrolled view of the popup window shown in the example of FIG. 7.

FIG. 9 illustrates a view of a popup window containing a contextual menu.

FIG. 10 is a block diagram illustrating example hardware components of a computing device.

### DETAILED DESCRIPTION

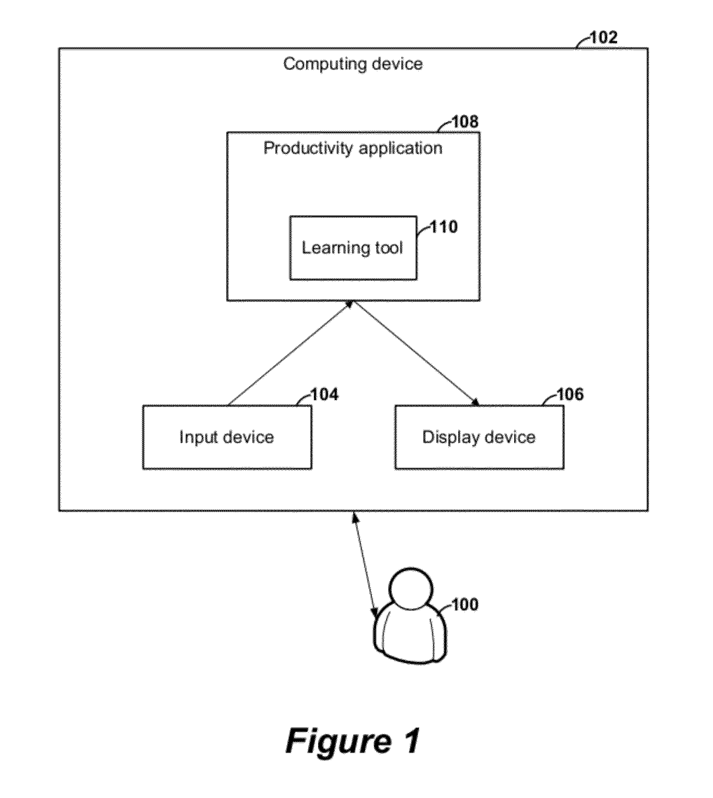

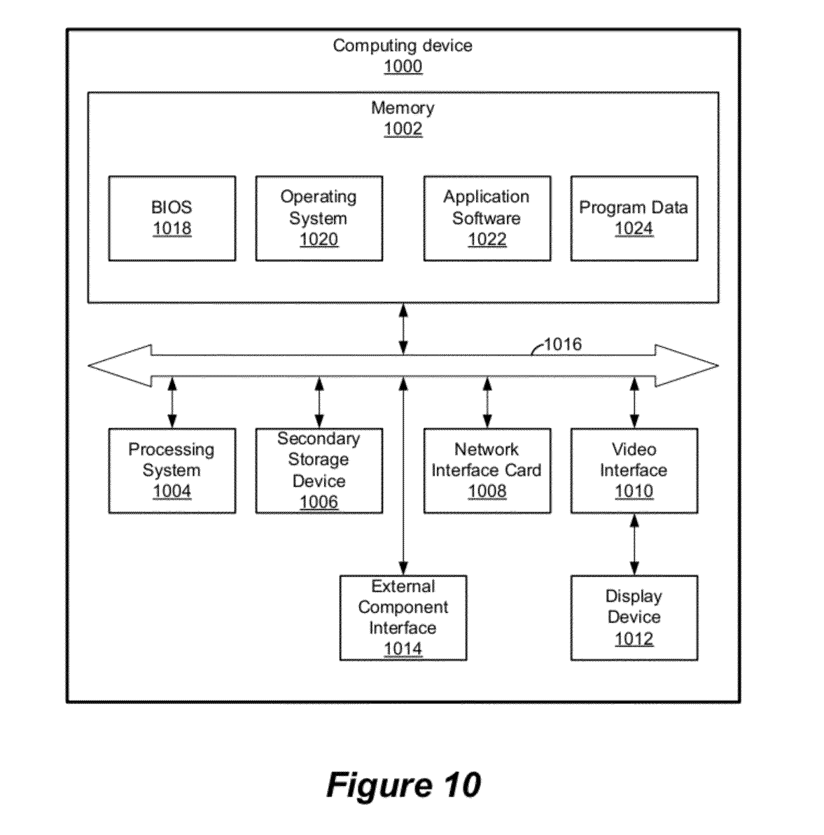

FIG. 1 is a block diagram illustrating a first example embodiment. As illustrated in the example of FIG. 1, a user 100 uses a computing device 102. The computing device 102 can be various types of computing device. For example, the computing device 102 can be a personal computer, a laptop computer, a handheld computer, a tablet computer, a smart phone, or another type of computer. In some instances, the computing device 102 can be a computing device of the type illustrated in the example of FIG. 10.

The computing device 102 comprises an input device 104 and a display device 106. The input device 104 enables the computing device 102 to receive input from the user 100. For example, the input device 104 can be a mouse, a keyboard, a microphone, a touch screen, a keypad, or another type of device that enables the computing device 102 to receive input from the user 100. The display device 106 is a device that is capable of displaying a user interface to the user 100. For example, the display device 106 can be a computer monitor, a touch screen, a television screen, a projector, or another type of device that is capable of displaying a user interface to the user 100.

In the example of FIG. 1, a productivity application 108 runs on the computing device 102. The productivity application 108 can be a variety of different types of application. For example, the productivity application 108 can be a word processing application such as MICROSOFT® Word, a spreadsheet application such as MICROSOFT® EXCEL®, a database access application such as MICROSOFT® ACCESS®, a note taking application such as MICROSOFT® ONENOTE®, a slide presentation application such as MICROSOFT® POWERPOINT®, a software development application such as MICROSOFT® VISUAL STUDIO®, a drawing application such as MICROSOFT® VISIO®, or another type of application. The productivity application 108 receives input from the user 100 via the input device 104.

The productivity application 108 displays a user interface to the user 100 via the display device 106. The user interface comprises a ribbon-shaped user interface. The ribbon-shaped user interface has multiple tabs. Each of the tabs comprises multiple user-selectable controls. Selection of the controls causes the productivity application 108 to perform commands. For example, selection of a given control can cause the productivity application 108 to apply a selected font to a block of text in a document. The user 100 is trying to learn how to use the ribbon-shaped user interface effectively.

Furthermore, a learning tool 110 runs on the computing device 102. The learning tool 110 can implement a method for teaching the user 100 to use the ribbon-shaped user interface. For example, the learning tool 110 can implement the RIBBON HERO™ tool for teaching user to use ribbon-shaped user interfaces. For ease of explanation, this patent document can describe functionality associated with the learning tool 110 as being performed by the learning tool 110. However, the learning tool 110 can be related to the productivity application 108 in various ways. For example, the learning tool 110 can be part of the productivity application 108. In another example, the learning tool 110 can be a plug-in for the productivity application 108. In yet another example, the learning tool 110 can be an update pack for the productivity application 108.

The learning tool 110 displays a series of challenges to the user 100 in the user interface of the productivity application 108. The challenges instruct the user 100 to use the ribbon-shaped user interface to perform various tasks. Because the user 100 is merely learning how to use the ribbon-shaped user interface, the learning tool 110 provides a hint button in the user interface. When the user 100 selects the hint button, the learning tool 110 displays one or more hints to help the user 100 use the ribbon-shaped user interface to complete the tasks specified by the challenges.

To further help the user 100 use the ribbon-shaped user interface to complete a task specified by a challenge, the learning tool 110 can display a tab visualization control in the user interface. When the user 100 provides input to select the tab visualization control, the learning tool 110 displays a popup window in the user interface. At least a horizontal onscreen dimension of the popup window is smaller than the horizontal onscreen dimension of the ribbon-shaped user interface. The popup window contains an image of a portion of a given tab in the ribbon-shaped user interface. The portion of the given tab can be displayed in the popup window at approximately the same size as the given tab is displayed in the ribbon-shaped user interface. The popup window only contains a portion of the given tab because the horizontal onscreen dimension of the popup window is smaller than the horizontal onscreen dimension of the ribbon-shaped user interface. Initially, the popup window shows a leftmost portion of the given tab.

The given tab contains a target control. Performance of a task specified by one of the challenges can involve selection of the target control. Because the target control may not initially be in the portion of the given tab displayed in the popup window, the learning tool 110 scrolls the image of the given tab within the popup window until the target control is displayed. Scrolling the image of the given tab within the popup window in this manner can help the user 100 locate the target control within the ribbon-shaped user interface.

To further help the user 100 learn to select the target control when performing a task specified by a challenge, the learning tool 110 can draw attention to the target control within the popup window. In various embodiments, the learning tool 110 can draw attention to the target control in various ways. For example, the learning tool 110 can display a colored pulsing frame around the target control. In another example, the learning tool 110 can display a still frame around the target control. In yet another example, the learning tool 110 can magnify the target control within the popup window.

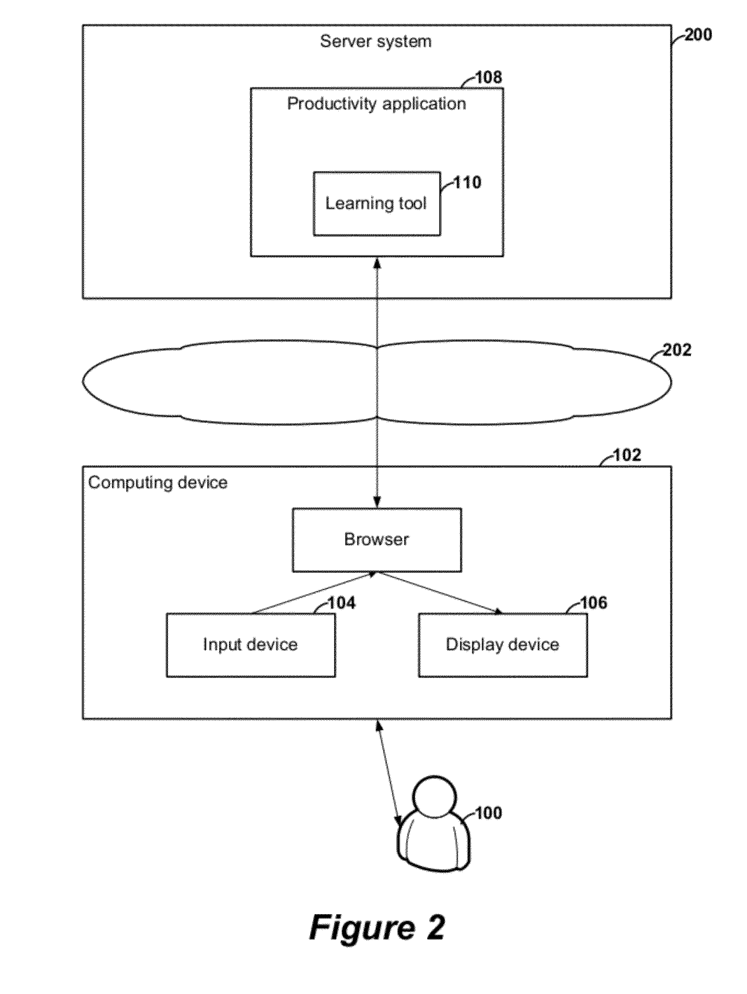

FIG. 2 is a block diagram illustrating a second example embodiment. In the example of FIG. 2, the productivity application 108 and the learning tool 110 run on a server system 200. The server system 200 comprises one or more computing devices. For example, the server system 200 can comprise one or more standalone server devices, blade server devices, mainframe computers, or other types of computing devices. In some instances, the server system 200 comprises one or more computing devices of the type illustrated in the example of FIG. 10. The server system 200 is remote from the computing device 102.

The computing device 102 and the server system 200 communicate via a network 202. The network 202 can be a variety of different types of network. For example, the network 202 can be the Internet. In another example, the network 202 can be a local area network, a virtual local area network, a virtual private network, or another type of network.

In the example of FIG. 2, a browser application 204, such as MICROSOFT® INTERNET EXPLORER®, runs on the computing device 102. The browser application 204 receives data from the productivity application 108 via the network 202. The browser application 204 uses this data to display the user interface of the productivity application 108 on the display device 106. In addition, the browser application 204 sends data representing user input to the productivity application 108 via the network 202. In this way, the productivity application 108 can display a user interface and receive input from the user 100 even though the productivity application 108 operates on the server system 200.

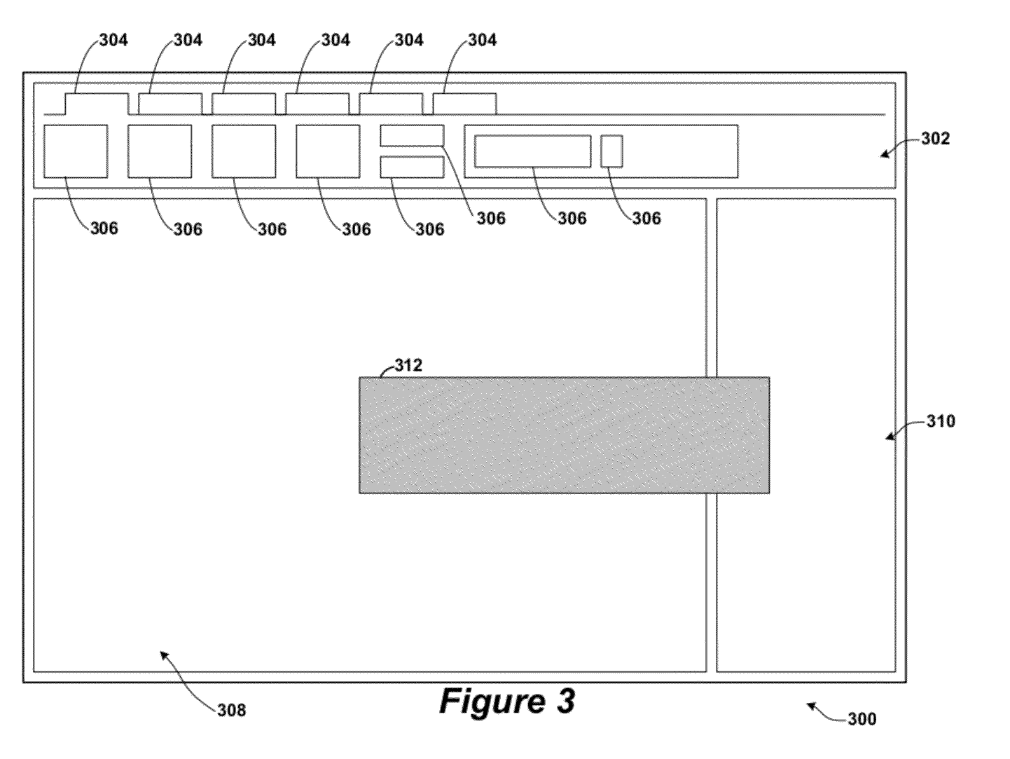

FIG. 3 illustrates an example user interface 300 of the productivity application 108. As illustrated in the example of FIG. 3, the user interface 300 comprises a ribbon-shaped user interface 302. The ribbon-shaped user interface 302 comprises a set of tabs 304. The ribbon-shaped user interface 302 currently displays controls 306 in a first one of the tabs 304.

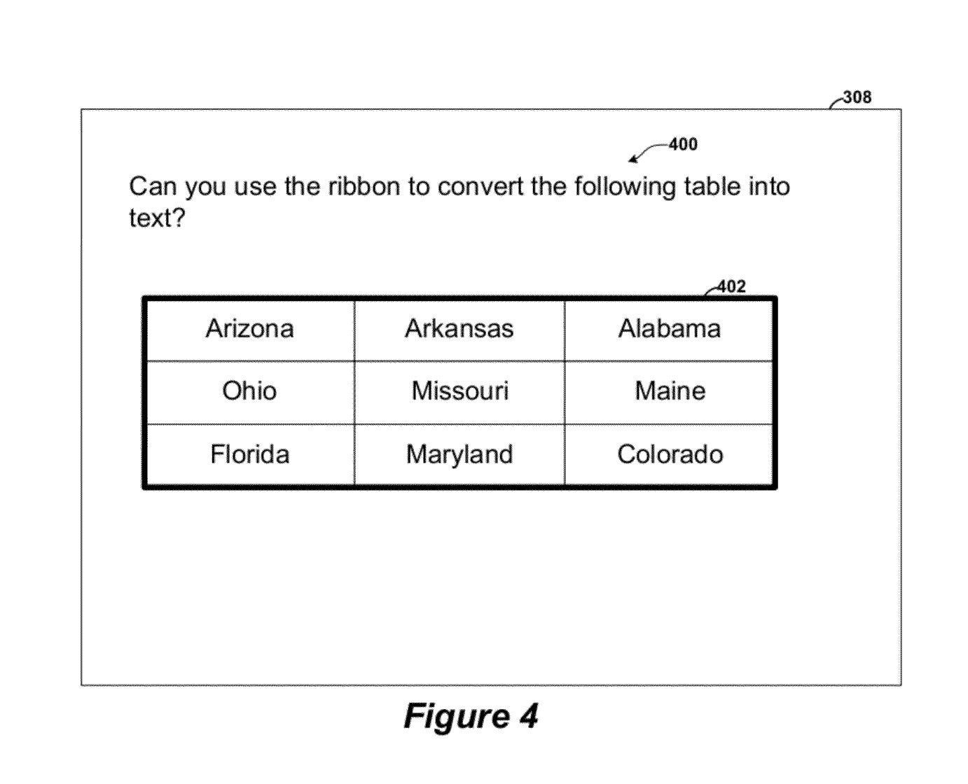

Furthermore, the user interface 300 also comprises a document pane 308. The document pane 308 displays at least a portion of a document. For instance, the document pane 308 can display at least a portion of a word processor document, a slideshow, a spreadsheet, or another type of document. FIG. 4, described in detail below, provides example details of the document pane 308.

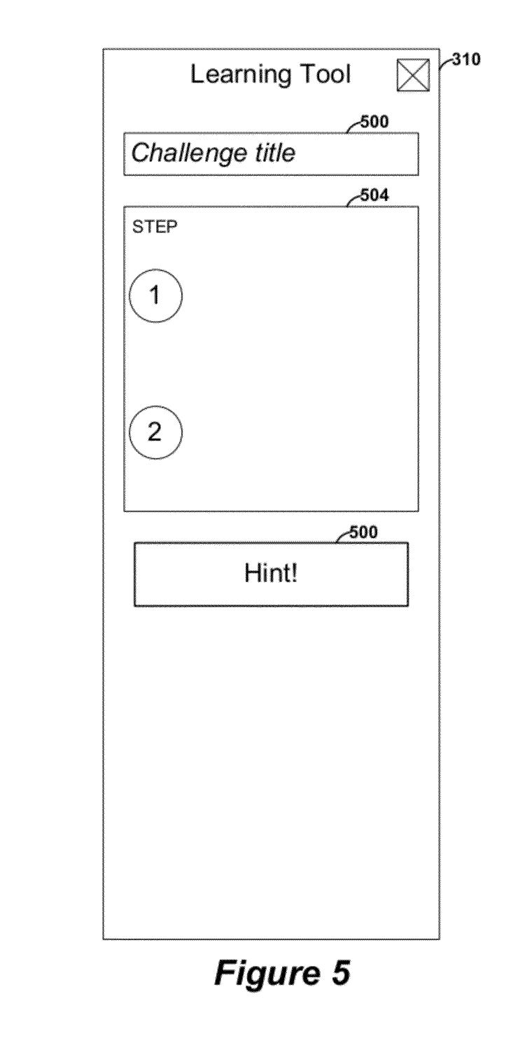

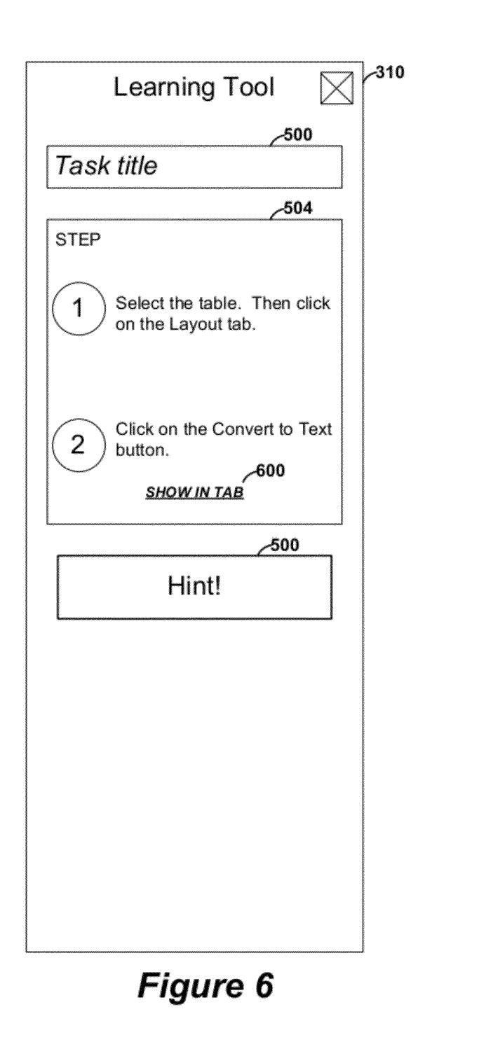

The user interface 300 also comprises a learning tool pane 310. The learning tool 110 can use the learning tool pane 310 to display hints for completing tasks specified by challenges. FIGS. 5 and 6, described in detail below, provide example details regarding the learning tool pane 310.

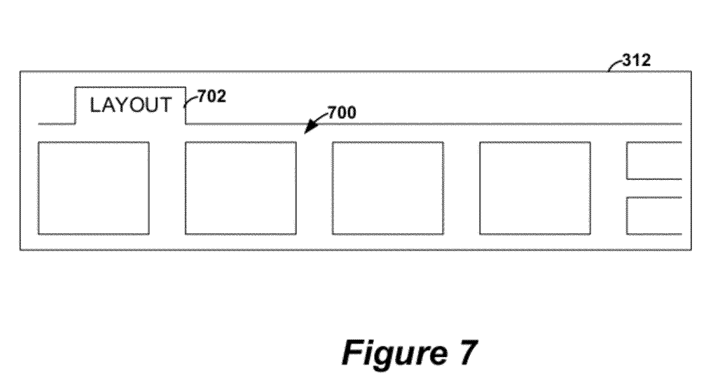

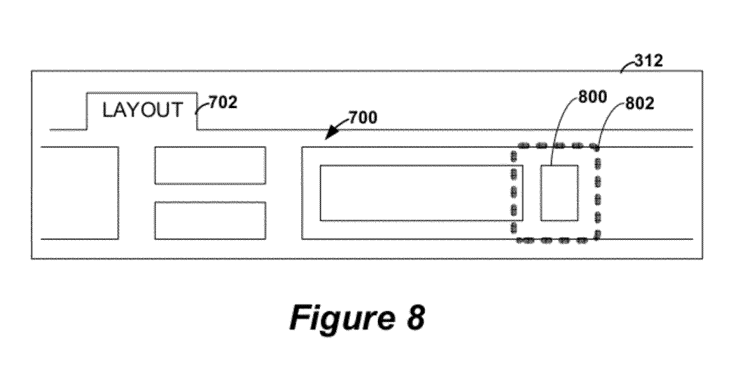

The user interface 300 also contains a popup window 312. The learning tool 110 displays the popup window 312 in the user interface 300 to further help the user 100 learn how to use the ribbon-shaped user interface 302 to complete a task specified by a challenge. The user interface 300 does not initially contain the popup window 312. Rather, the learning tool 110 can display the popup window 312 in the user interface 300 in response to input from the user 100 at some time after the other parts of the user interface 300 are displayed. FIGS. 7 and 8, described in detail below, provide example details regarding the popup window 312. Although the popup window 312 is shown in the example of FIG. 3 as overlapping the document pane 308 and the learning tool pane 310, it should be appreciated that the popup window 312 can appear at other positions within the user interface 300. For example, the popup window 312 can appear exclusively over the learning tool pane 310.

FIG. 4 illustrates example details of the document pane 308 of the user interface 300. As illustrated in the example of FIG. 4, the document pane 308 comprises challenge text 400. The challenge text 400 challenges the user 100 to perform a task using the ribbon-shaped user interface 302. The document pane 308 can also contain one or more elements on which the user 100 is to perform the task specified by the challenge text 400. For instance, in the example of FIG. 4, the document pane 308 comprises a table 402. The challenge text 400 instructs the user to perform a task on the table 402. In particular, the challenge text 400 instructs the user 100 to use the ribbon-shaped user interface 302 to convert the table 402 into text.

It should be appreciated that the document pane 308 can include challenge text instructing the user 100 to use the ribbon-shaped user interface 302 to perform other tasks and can include content other than the table 402. For instance, if the productivity application 108 is a spreadsheet application, the document pane 308 can include challenge text that instructs the user 100 to use the ribbon-shaped user interface 302 to sort rows in a spreadsheet based on the values in a given column.

FIG. 5 illustrates example details of a learning tool pane 310 before the user 100 selects a hint control 500 in the learning tool pane 310. As illustrated in the example of FIG. 5, the learning tool pane 310 comprises a challenge title area 502. The challenge title area 502 comprises text stating a name of a challenge that the learning tool 110 is currently asking the user 100 to perform. In addition, the learning tool pane 310 comprises a step area 504. Initially, the step area 504 does not contain text describing steps for completing the task specified by the challenge.

FIG. 6 illustrates example details of the learning tool pane 310 shown in the example of FIG. 5 after the user 100 selects the hint control 500 in the learning tool pane 310. When the user 100 selects the hint control 500, the learning tool 110 causes the step area 504 of the learning tool pane 310 to contain text describing steps for using the ribbon-shaped user interface 302 to complete the task specified by the challenge. As illustrated in the example of FIG. 6, a first step for completing the task specified by the challenge is “Select the table. Then click on the Layout tab.” A second step for completing the task specified by the challenge is “Click on the Convert to Text button.”

Furthermore, when the user 100 selects the hint control 500, the learning tool 110 causes the learning tool pane 310 to contain a popup control 600. In the example of FIG. 6, the popup control 600 is labeled “Show in Tab.” It should be appreciated that the popup control 600 can, in various embodiments, have different labels or comprise an icon/button that is or is not accompanied by text. When the user 100 selects the popup control 600, the learning tool 110 causes the popup window 312 to appear in the user interface 300. In the example of FIG. 6, the popup window 312 can show the user 100 how to select the “Convert to Text” button in the “Layout” tab of the ribbon-shaped user interface 302. In various embodiments, the user 100 can select the popup control 600 in various ways. For example, the user 100 can select the popup control 600 by clicking the popup control 600 with a mouse pointer. In another example, the user 100 can select the popup control 600 by hovering over the popup control 600 with a mouse pointer.

Furthermore, in some embodiments, the learning tool 110 can display the popup window 312 in response to input from the user 100 that does not involve the popup control 600. For example, the learning tool 110 can display the popup window 312 in response to the user 100 providing one or more keystrokes on a keyword. In another example, the learning tool 110 can display the popup window 312 in response to a voice command or a gesture. In such embodiments, the user interface 300 may or may not contain the popup control 600.

FIG. 7 illustrates an initial view of the popup window 312. As illustrated in the example of FIG. 7, the popup window 312 shows an image of at least a portion of the controls in a tab 700 of the ribbon-shaped user interface 302. Furthermore, the popup window 312 displays a label 702 for the tab 700. In the example of FIG. 7, the label 702 indicates that the tab 700 is a “Layout” tab of the ribbon-shaped user interface 302.

The image of the tab 700 is not actually the tab in the ribbon-shaped user interface 302. For instance, the user 100 may not be able to select controls in the image of the tab 700. Rather, the learning tool 110 causes the popup window 312 to display the image of the tab 700 to guide the user 100 on how to find a control within an actual tab in the ribbon-shaped user interface 302.

Because the horizontal onscreen dimension of the popup window 312 is less than the horizontal onscreen dimension of the ribbon-shaped user interface 302, it may not be possible to display all of the controls in the tab 700 in the popup window 312 at one time. Rather, the popup window 312 is only able to display a portion of the controls in the tab 700. For example, the popup window 312 can initially display only the controls in a leftmost portion of the tab 700.

FIG. 8 illustrates a scrolled view of the popup window 312 shown in the example of FIG. 7. In some instances, the learning tool 110 may need to draw the attention of the user 100 to a target control 800 in the tab 700. The target control 800 is not initially displayed in the popup window 312. For example, the popup window 312 can initially display an image of only the controls in a leftmost portion of the tab 700. In this example, the target control 800 can be in a rightmost portion of the tab 700.

To show the target control 800 within the popup window 312, the learning tool 110 scrolls the image of the tab 700 within the popup window 312. For example, if the popup window 312 initially shows an image of a leftmost part of the tab 700, the learning tool 110 appears to move the controls in the tab 700 to the left over a period of time, thereby progressively exposing in the popup window 312 controls that are further right in the tab 700. The learning tool 110 stops scrolling the image of the tab 700 when the popup window 312 shows a control to which the learning tool 110 wants to attract the attention of the user 100 (e.g., the target control 800). Scrolling the image of the tab 700 in this way can help the user 100 learn where the target control 800 is located within the tab 700 by showing the user 100 where the target control 800 is located relative to the controls in the leftmost portion of the tab 700. In other words, by displaying the target control 800 at its location in the tab 700 relative to other controls in the tab 700, the user 100 may be better able to find the target control 800 when the user 100 next wants to perform the task specified by the challenge text 400.

As the learning tool 110 scrolls the image of the tab 700, the learning tool 110 does not move the label 702 for the tab 700 within the popup window 312. Rather, the label 702 remains at a fixed position within the popup window 312 while the image of the tab 700 scrolls within the popup window 312. Thus, the popup window 312 continues to display the label 702 even if the label for the tab 700 would not actually be displayed above the portion of the tab 700 shown in the popup window 312. By leaving the label 702 at the same position within the popup window 312, it may be easier for the user 100 to remember what tab is being displayed in the popup window 312.

In other embodiments, the learning tool 110 can initially display a rightmost portion of the image of the tab 700 and scroll the image of the tab 700 to display controls further left in the tab. Scrolling the image of the tab 700 to the right may have a more natural feel in some cultures.

Furthermore, in some embodiments, the learning tool 110 starts scrolling the image of the tab 700 within the popup window 312 automatically without receiving additional input from the user 100. In other embodiments, the learning tool 110 starts scrolling the image of the tab 700 within the popup window 312 in response to input from the user 100. Furthermore, in some embodiments, the learning tool 110 can scroll the image of the tab 700 back and forth within the popup window 312 in response to dragging input from the user 100.

To further draw the attention of the user 100 to the target control 800, the learning tool 110 displays a frame 802 around the target control 800. The frame 802 is a screen element designed to attract the attention of the user 100 to the target control 800. The frame 802 can have a high contrast color relative to the color of the image of the tab 700. Furthermore, in some embodiments, the frame 802 can flash or pulsate to draw the attention of the user 100 to the target control 800.

In other embodiments, the learning tool 110 can use visual elements other than a frame to draw attention to the target control 800. For example, the learning tool 110 can display one or more arrows pointing to the target control 800. In another example, the learning tool 110 can magnify the target control 800 relative to other controls in the image of the tab 700.

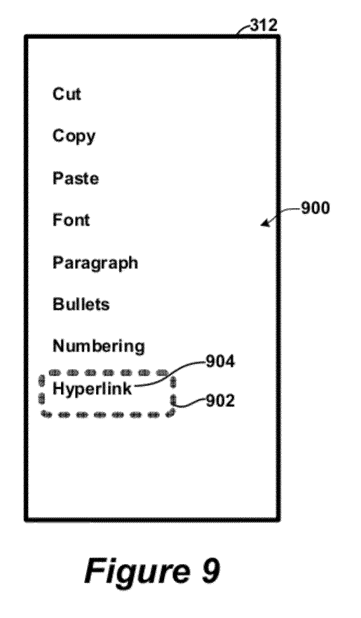

FIG. 9 illustrates a view of the popup window 312 containing a contextual menu image 900. In some embodiments, the challenge text 400 challenges the user 100 to perform a task using a contextual menu, instead of the ribbon-shaped user interface 302. For example, the challenge text 400 can challenge the user 100 to use the contextual menu to assign a hyperlink to a block of text. The productivity application 108 can present the contextual menu when the user 100 right-clicks on a given element in the document area 308 of the user interface 300. The contextual menu can contain different menu items depending on the type of given element.

The user 100 may be unfamiliar with using the contextual menu. Consequently, the user 100 may not know how to find menu items in the contextual menu. Accordingly, the user 100 can select the hint control 500 in the learning tool pane 310. In this context, selecting the hint control 500 causes the step area 504 of the learning tool pane 310 to contain text describing steps for using the contextual menu to complete the task specified by the challenge text 400. Selecting the hint control 500 also causes the learning tool pane 310 to contain the popup control 600. Selection of the popup control 600 causes the learning tool 110 to display the popup window 312.

Because the user 100 needs to use the contextual menu to complete the task specified by the challenge text 400, the popup window 312 contains the contextual menu image 900, instead of the image of a tab in the ribbon-shaped user interface 302. The contextual menu image 900 is an image of the contextual menu, and not the contextual menu itself. The user 100 may not be able to select menu items in the contextual menu image 900.

The popup window 312 comprises a frame 902. The frame 902 is a screen element designed to attract the attention of the user 100 to a target menu item 904. The target menu item 904 is a control in the contextual menu that the user 100 can use in performing the task specified by the challenge text 400. By displaying the target menu item 904 at its location in the contextual menu relative to other menu items in the contextual menu, the user 100 may be better able to find the target menu item 904 when the user 100 next wants to perform the task.

Furthermore, in some embodiments, the contextual menu may be too long in the vertical dimension for all menu items in the contextual menu to be displayed concurrently within the popup window 312. In such embodiments, the learning tool 110 can initially display a top portion of the contextual menu image 900 in the popup window 312. The learning tool 110 can then scroll down the contextual menu image 900 until the target menu item 904 is displayed within the popup window 312. In this way, the popup window 312 displays the target menu item 904 at its location relative to other menu items in the contextual menu. As a result, the user 100 may later be better able to find the target menu item 904 in the contextual menu even if the target menu item 904 is low in the contextual menu.

It should be appreciated that FIGS. 7, 8, and 9 show examples of how the learning tool 110 can display a target control in the popup window 312 at its location relative to other controls in a control cluster. In other embodiments, the learning tool 110 can display target controls in the popup window 312 at their locations relative to other controls in other types of control clusters. For example, the learning tool 110 can cause the popup window 312 to show a target control at its location relative to other controls in a toolbar, a non-contextual menu, or another type of control cluster. In this way, the learning tool 110 can help the user 100 learn how to use controls in various types of control clusters.

FIG. 10 is a block diagram illustrating an example computing device 1000. In some embodiments, the computing device 102 and the server system 200 are implemented as one or more computing devices like the computing device 1000. It should be appreciated that in other embodiments, the computing device 102 and the server system 200 are implemented using computing devices having hardware components other than those illustrated in the example of FIG. 10.

The term computer readable media as used herein may include computer storage media and communication media. As used in this document, a computer storage medium is a device or article of manufacture that stores data and/or computer-executable instructions. Computer storage media may include volatile and nonvolatile, removable and non-removable devices or articles of manufacture implemented in any method or technology for storage of information, such as computer readable instructions, data structures, program modules, or other data. By way of example, and not limitation, computer storage media may include dynamic random access memory (DRAM), double data rate synchronous dynamic random access memory (DDR SDRAM), reduced latency DRAM, DDR2 SDRAM, DDR3 SDRAM, solid state memory, read-only memory (ROM), electrically-erasable programmable ROM, optical discs (e.g., CD-ROMs, DVDs, etc.), magnetic disks (e.g., hard disks, floppy disks, etc.), magnetic tapes, and other types of devices and/or articles of manufacture that store data. Communication media may be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media.

In the example of FIG. 10, the computing device 1000 comprises a memory 1002, a processing system 1004, a secondary storage device 1006, a network interface card 1008, a video interface 1010, a display unit 1012, an external component interface 1014, and a communication medium 1016. The memory 1002 includes one or more computer storage media capable of storing data and/or instructions. In different embodiments, the memory 1002 is implemented in different ways. For example, the memory 1002 can be implemented using various types of computer storage media.

The processing system 1004 includes one or more processing units. A processing unit is a physical device or article of manufacture comprising one or more integrated circuits that selectively execute software instructions. In various embodiments, the processing system 1004 is implemented in various ways. For example, the processing system 1004 can be implemented as one or more processing cores. In another example, the processing system 1004 can comprise one or more separate microprocessors. In yet another example embodiment, the processing system 1004 can comprise an application-specific integrated circuit (ASIC) that provides specific functionality. In yet another example, the processing system 1004 provides specific functionality by using an ASIC and by executing computer-executable instructions.

The secondary storage device 1006 includes one or more computer storage media. The secondary storage device 1006 stores data and software instructions not directly accessible by the processing system 1004. In other words, the processing system 1004 performs an I/O operation to retrieve data and/or software instructions from the secondary storage device 1006. In various embodiments, the secondary storage device 1006 comprises various types of computer storage media. For example, the secondary storage device 1006 can comprise one or more magnetic disks, magnetic tape drives, optical discs, solid state memory devices, and/or other types of computer storage media.

The network interface card 1008 enables the computing device 1000 to send data to and receive data from a communication network. In different embodiments, the network interface card 1008 is implemented in different ways. For example, the network interface card 1008 can be implemented as an Ethernet interface, a token-ring network interface, a fiber optic network interface, a wireless network interface (e.g., WiFi, WiMax, etc.), or another type of network interface.

The video interface 1010 enables the computing device 1000 to output video information to the display unit 1012. The display unit 1012 can be various types of devices for displaying video information, such as a cathode-ray tube display, an LCD display panel, a plasma screen display panel, a touch-sensitive display panel, an LED screen, or a projector. The video interface 1010 can communicate with the display unit 1012 in various ways, such as via a Universal Serial Bus (USB) connector, a VGA connector, a digital visual interface (DVI) connector, an S-Video connector, a High-Definition Multimedia Interface (HDMI) interface, or a DisplayPort connector.

The external component interface 1014 enables the computing device 1000 to communicate with external devices. For example, the external component interface 1014 can be a USB interface, a FireWire interface, a serial port interface, a parallel port interface, a PS/2 interface, and/or another type of interface that enables the computing device 1000 to communicate with external devices. In various embodiments, the external component interface 1014 enables the computing device 1000 to communicate with various external components, such as external storage devices, input devices, speakers, modems, media player docks, other computing devices, scanners, digital cameras, and fingerprint readers.

The communications medium 1016 facilitates communication among the hardware components of the computing device 1000. In the example of FIG. 10, the communications medium 1016 facilitates communication among the memory 1002, the processing system 1004, the secondary storage device 1006, the network interface card 1008, the video interface 1010, and the external component interface 1014. The communications medium 1016 can be implemented in various ways. For example, the communications medium 1016 can comprise a PCI bus, a PCI Express bus, an accelerated graphics port (AGP) bus, a serial Advanced Technology Attachment (ATA) interconnect, a parallel ATA interconnect, a Fiber Channel interconnect, a USB bus, a Small Computing system Interface (SCSI) interface, or another type of communications medium.

The memory 1002 stores various types of data and/or software instructions. For instance, in the example of FIG. 10, the memory 1002 stores a Basic Input/Output System (BIOS) 1018 and an operating system 1020. The BIOS 1018 includes a set of computer-executable instructions that, when executed by the processing system 1004, cause the computing device 1000 to boot up. The operating system 1020 includes a set of computer-executable instructions that, when executed by the processing system 1004, cause the computing device 1000 to provide an operating system that coordinates the activities and sharing of resources of the computing device 1000. Furthermore, the memory 1002 stores application software 1022. The application software 1022 comprises computer-executable instructions, that when executed by the processing system 1004, cause the computing device 1000 to provide one or more applications. The memory 1002 also stores program data 1024. The program data 1024 is data used by programs that execute on the computing device 1000.

The various embodiments described above are provided by way of illustration only and should not be construed as limiting. Those skilled in the art will readily recognize various modifications and changes that may be made without following the example embodiments and applications illustrated and described herein. For example, the operations shown in the figures are merely examples. In various embodiments, similar operations can include more or fewer steps than those shown in the figures. Furthermore, in other embodiments, similar operations can include the steps of the operations shown in the figures in different orders.

What is claimed is:

1. A method for teaching a user how to use a ribbon-shaped user interface, the method comprising:
displaying, by a computing device, a user interface, the user interface containing the ribbon-shaped user interface, the ribbon-shaped user interface containing multiple tabs, each of the tabs containing multiple controls;
displaying, by the computing device, a challenge in the user interface, the challenge instructing the user to perform a task using the ribbon-shaped user interface without instructing the user how to perform the task, wherein performance of the task using the ribbon-shaped user interface involves selection of a target control in a given tab in the ribbon-shaped user interface;
in response to input from the user, displaying a popup window in the user interface, the popup window initially containing an image of an initial portion of the given tab; and
scrolling, by the computing device, the image of the given tab within the popup window such that the target control in the given tab is visible within the popup window.

2. The method of claim 1, further comprising displaying, by the computing device, a screen element designed to attract attention of the user to the target control within the popup window.

3. The method of claim 2, wherein the screen element is a pulsing frame around the target control.

4. The method of claim 1, wherein the popup window contains a label for the given tab, the label remaining at a fixed position within the popup window while the image of the given table scrolls within the popup window.

5. The method of claim 1, further comprising:
displaying a hint control in the user interface; and
in response to receiving the selection of the hint control, displaying, by the computing device, text describing how to use the ribbon-shaped user interface to complete the task.

6. The method of claim 5, further comprising: displaying a document pane in the user interface, the document pane containing the challenge and an element on which the user is to perform the task.

7. The method of claim 1, wherein the initial portion of the given tab is a leftmost portion of the given tab.

8. The method of claim 1, wherein the target control is not visible within the portion of the given tab initially displayed in the popup window.

9. The method of claim 1, wherein the computing device scrolls the image of the given tab within the popup window without receiving additional input from the user.

10. The method of claim 1, further comprising scrolling the image of the given tab back and forth within the popup window in response to dragging input from the user.

11. The method of claim 1, further comprising:
displaying, by the computing device, a second challenge in the user interface, the second challenge instructing the user to perform a second task using a menu without instructing the user how to perform the second task, wherein performance of the second task using the menu involves selection of a target menu item in the menu; and
in response to second input from the user, displaying a second popup window in the user interface, the second popup window initially containing a menu image, the menu image being an image of the menu, the popup window containing a screen element drawing attention of the user to the target menu item.

12. A computing device comprising:
a processing unit that executes stored computer-executable instructions, execution of the computer-executable instructions causing the computing device to run a productivity application that:
displays a user interface on a display device, the user interface containing a ribbon-shaped user interface and a document pane, the ribbon-shaped user interface containing multiple tabs, each of the tabs containing multiple controls, the document pane containing at least a portion of a document;
displays a challenge and a tab visualization control in the user interface, the challenge instructing a user to perform a task using the ribbon-shaped user interface without instructing the user how to perform the task on the document, performance of the task using the ribbon-shaped user interface involving selection of a target control in a given tab in the ribbon-shaped user interface;
displays a tab visualization control in the user interface;
in response to input from the user to select the tab visualization control, displays a popup window in the user interface, the popup window initially containing an image of an initial portion of the given tab in the ribbon-shaped user interface; and
scrolls the image of the given tab within the popup window such that the target control in the given tab is visible within the popup window.

13. The computing device of claim 12, wherein the productivity application displays a screen element designed to attract attention of the user to the target control within the popup window.

14. The computing device of claim 12, wherein the computing device comprises an input device and the display device, the productivity application receiving input from the user via the input device.

15. The computing device of claim 12,
wherein the computing device is part of a server system; and
wherein the productivity application displays the user interface by sending data to a browser application operating on another computing device.

16. The computing device of claim 12, wherein the popup window contains a label for the given tab, the label remaining at a fixed position within the popup window while the image of the given table scrolls within the popup window.

17. The computing device of claim 12, wherein the productivity application displays text describing how to use the ribbon-shaped user interface to complete the task.

18. The computing device of claim 12, wherein the target control is not visible within the portion of the given tab initially displayed in the popup window.

19. The computing device of claim 12, wherein the productivity application scrolls the image of the given tab within the popup window in response to receiving additional input from the user.

20. A computer storage medium that stores computer-executable instructions that, when executed by a computing device, cause the computing device to:
display a user interface on a display device, the user interface containing a ribbon-shaped user interface and a document pane, the ribbon-shaped user interface containing multiple tabs, each of the tabs containing multiple controls, the document pane containing at least a portion of a document;
display a challenge and a hint control in the user interface, the challenge instructing a user to perform a task on the document using the ribbon-shaped user interface without instructing the user how to perform the task, performance of the task on the document using the ribbon-shaped user interface involving selection of a target control in a given tab in the ribbon-shaped user interface;
in response to receiving a selection of the hint control, display a tab visualization control and text describing one or more steps for how to use the ribbon-shaped user interface to complete the task;
in response to input from the user to select the tab visualization control, display a popup window in the user interface, the popup window initially containing an image of an initial portion of the given tab in the ribbon-shaped user interface, the popup window contains a label for the given tab, wherein the target control is not visible within the portion of the given tab initially displayed in the popup window;
scroll the image of the given tab within the popup window such that the target control in the given tab is visible within the popup window, the label remaining at a fixed position within the popup window while the image of the given tab scrolls within the popup window;
display a screen element designed to attract attention of the user to the target control within the popup window, the screen element being a pulsing frame around the target control; and
scroll the image of the given tab back and forth within the popup window in response to dragging input from the user.
